(19) United States
(12) Patent Application Publication
(10) Pub. No.: US 2024/0308204 A1
(43) Pub. Date: Sep. 19, 2024

(54) RECORDING APPARATUS

(71) Applicant: BROTHER KOGYO KABUSHIKI KAISHA, Nagoya (JP)

(72) Inventor: Yoshinori OSAKABE, Seto (JP)

(21) Appl. No.: 18/415,888

(22) Filed: Jan. 18, 2024

(30) Foreign Application Priority Data
Mar. 17, 2023 (JP) 2023-042807

(51) Int. Cl. B41J 2/045; B41J 2/175; B41J 13/00

(52) U.S. Cl. CPC B41J 2/04526; B41J 2/04586; B41J 2/17506; B41J 2/17546; B41J 13/0027

(57) ABSTRACT

A recording apparatus, having a head including first nozzles and second nozzles, a carriage, a relative-movement device, a first reservoir, a second reservoir, and a controller, is provided. The controller repeats one of a set of a multiple-liquids recording pass, where liquids in different types are discharged from the first nozzles and the second nozzles, and a first relative-movement action, where the head and a recording medium are moved relatively in a relative-movement direction, and a set of a single-liquid recording pass, where a liquid in a same type is discharged from the first nozzles and the second nozzles, and a second relative-movement action, where the head and the recording medium are moved relatively in the relative-movement direction. A resolution of an image recorded in the single-liquid recording pass is higher than a resolution of an image recorded in the multiple-liquids recording pass in the relative-movement direction.

### REFERENCE TO RELATED APPLICATIONS

This application claims priority from Japanese Patent Application No. 2023-042807, filed on Mar. 17, 2023. The entire content of the priority application is incorporated herein by reference.

### BACKGROUND ART

A recording apparatus for recording images on a recordable medium by discharging liquid from nozzles, such as an inkjet printer that may discharge ink from nozzles at a sheet, is known. The inkjet printer may have a head having a plurality of nozzles. The plurality of nozzles may form linear nozzle rows including, for example, row A and row B arrayed along a sheet-conveying direction. The inkjet printer may have a carriage, on which the head is mounted, and the inkjet printer may record an image on the sheet by repeating a recording pass, in which the carriage is moved in a direction orthogonal to the sheet-conveying direction and the ink is discharged from the nozzles forming the row A and the row B, and a conveying action to convey the sheet in the sheet-conveying direction, alternately. The inkjet printer may print the image in multiple colors by discharging inks in different colors from a downstream half of the nozzles forming the row A in the sheet-conveying direction, an upstream half of the nozzles forming the row A in the sheet-conveying direction, a downstream half of the nozzles forming the row B in the sheet-conveying direction, and an upstream half of the nozzles forming the row B in the sheet-conveying direction. On the other hand, the inkjet printer may print an image in monochrome by discharging ink in a single color from all of the nozzles forming both the row A and the row B.

### DESCRIPTION

In the known inkjet printer, the nozzles in the row A and the nozzles in the row B may be located at the same positions in the sheet-conveying direction. Therefore, a resolution of the image in the sheet-conveying direction recordable in a single recording pass in the multicolor printing and a resolution of the image in the sheet-conveying direction recordable in a single recording pass in the monochrome printing may be the same.

The present disclosure is advantageous in that a recording apparatus, in which a resolution of an image recorded in a recording pass in a relative-movement direction between a head and a recordable medium is increased when the image is recorded in a single type of liquid compared to an image recorded in multiple types of liquids, is provided.

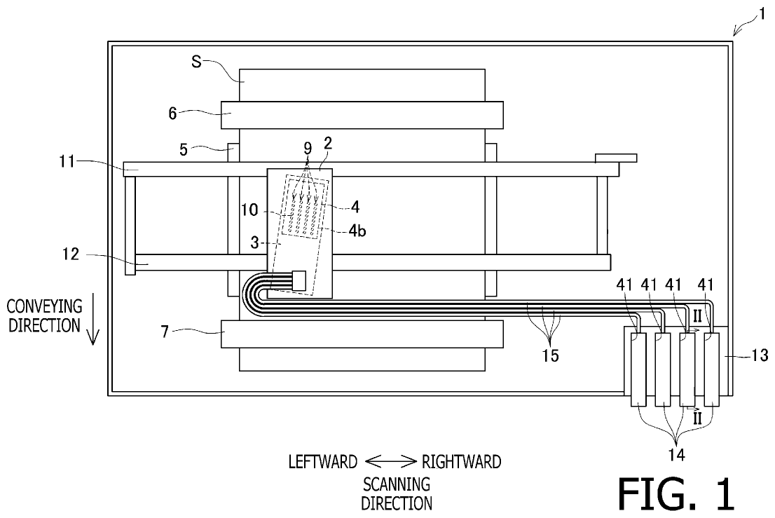

FIG. 1 is an illustrative overall view of a printer.

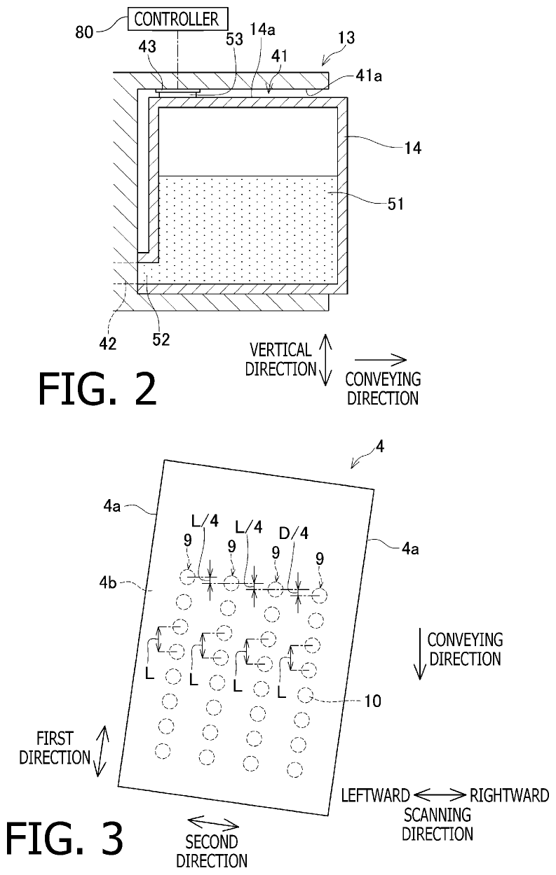

FIG. 2 is a cross-sectional view of a part of the printer viewed along a line II-II shown in FIG. 1.

FIG. 3 is an enlarged view of an inkjet head.

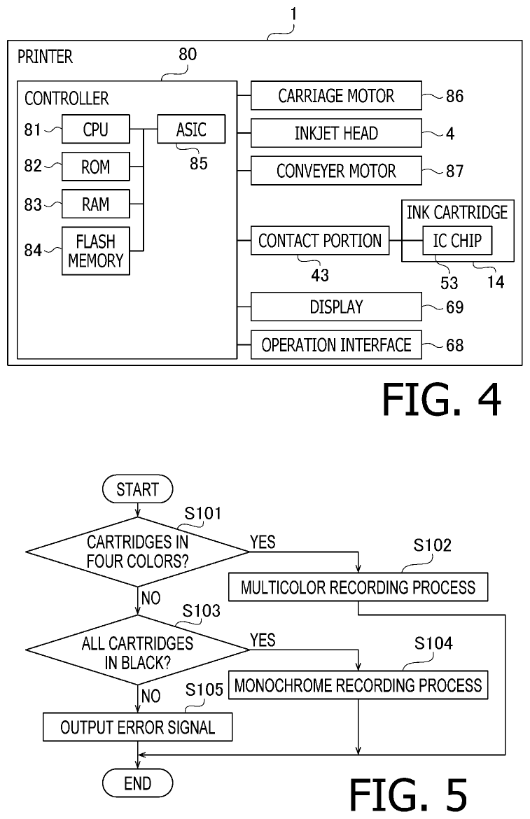

FIG. 4 is a block diagram to illustrate an electric configuration of the printer.

FIG. 5 is a flowchart to illustrate a flow of steps in a process for recording an image.

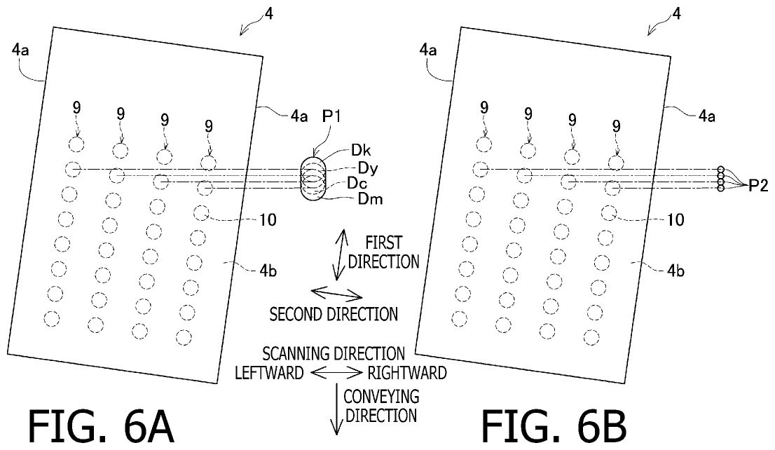

FIG. 6A is an illustrative view of the inkjet head recording an image in a multicolor recording process. FIG. 6B is an illustrative view of the inkjet head recording an image in a monochrome recording process.

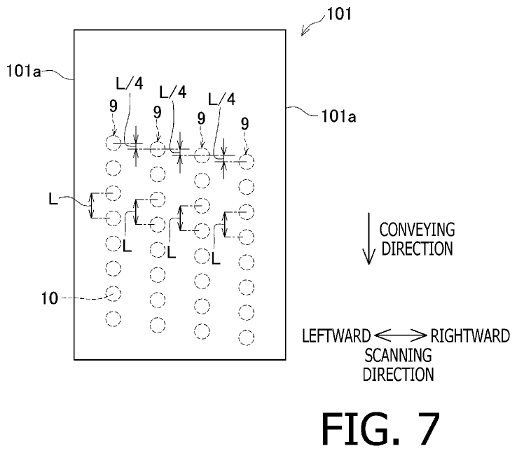

FIG. 7 is an illustrative view of the inkjet head, in which positions of nozzles aligned in a conveying direction are offset from one another in the conveying direction among a plurality of nozzle rows.

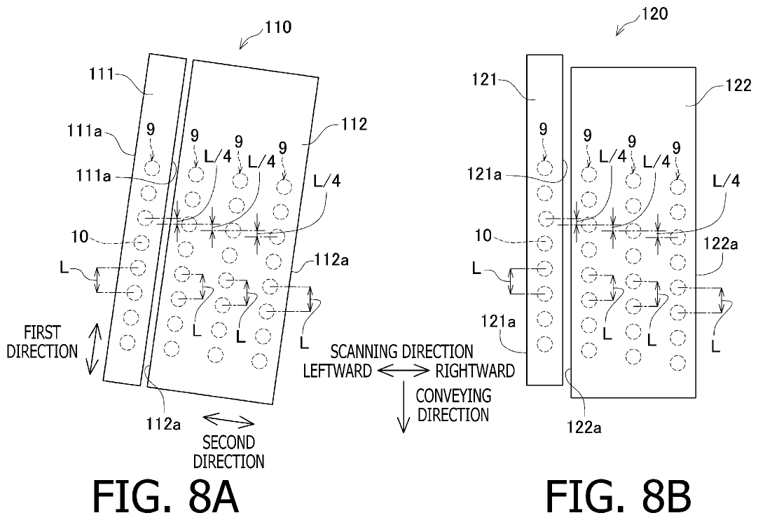

FIG. 8A is an illustrative view of the inkjet head consisting of a head unit for black ink and a head unit for multicolored inks, in which the nozzles are aligned in a first direction.

FIG. 8B is an illustrative view of the inkjet head consisting of a head unit for black ink and a head unit for multicolored inks, in which the nozzles are aligned in a conveying direction, and in which positions of the nozzles in the conveying direction are offset from one another among the nozzle rows.

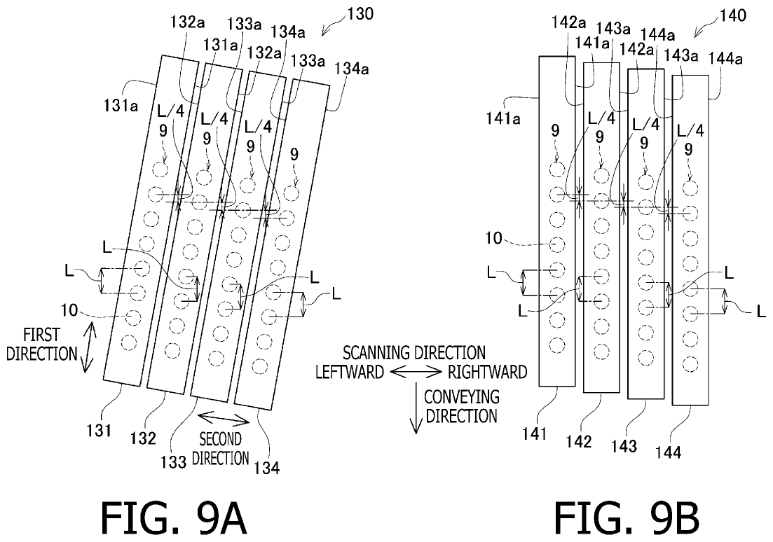

FIG. 9A is an illustrative view of an inkjet head consisting of four head units, each of which has a nozzle row, and in which the nozzles are aligned in the first direction. FIG. 9B is an illustrative view of an inkjet head consisting of four head units, each of which has a nozzle row, and in which the nozzles are aligned in the conveying direction, and positions of the nozzles in the conveying direction are offset from one another among the nozzle rows.

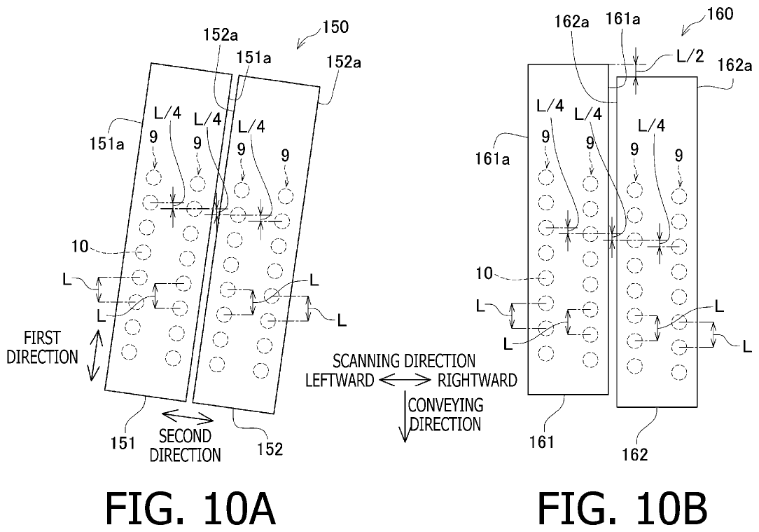

FIG. 10A is an illustrative view of an inkjet head consisting of two head units, each of which has two nozzle rows, and in which the nozzles are aligned in the first direction. FIG. 10B is an illustrative view of an inkjet head consisting of two head units, each of which has two nozzle rows, and in which the nozzles ae aligned in the conveying direction, and in which positions of the nozzles are offset in the conveying direction from one another among the nozzle rows.

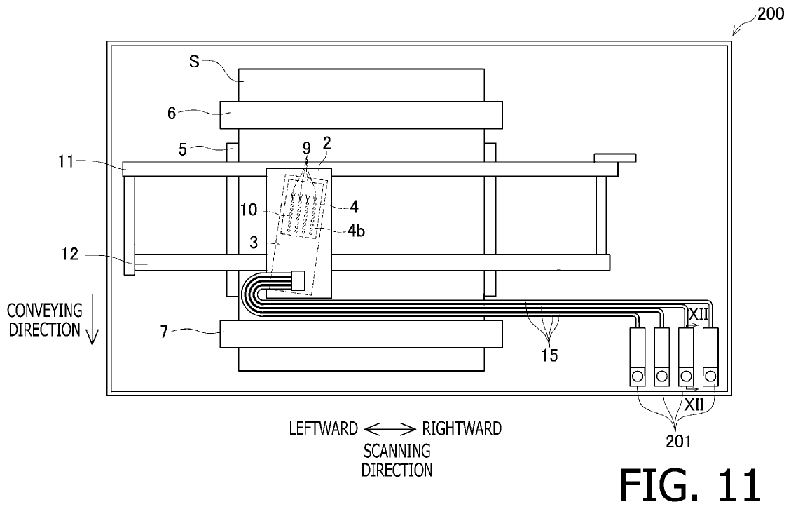

FIG. 11 is an illustrative view of a printer with ink tanks having ink refilling ports.

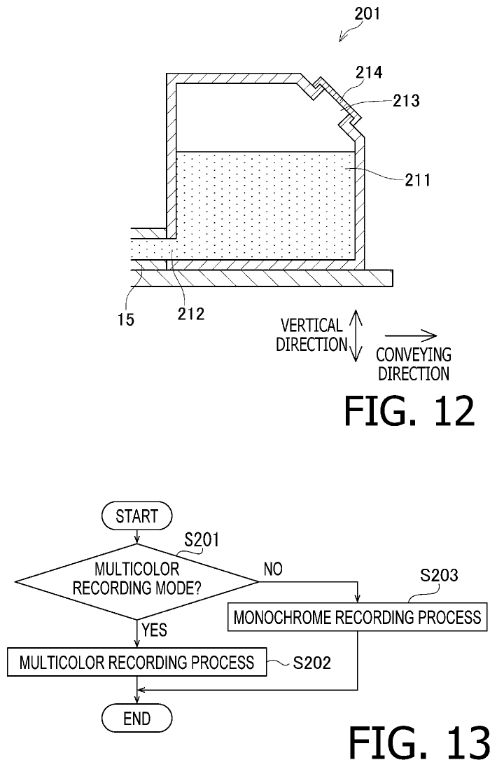

FIG. 12 is a cross-sectional view of one of the ink tanks viewed along a line XII-XII shown in FIG. 11.

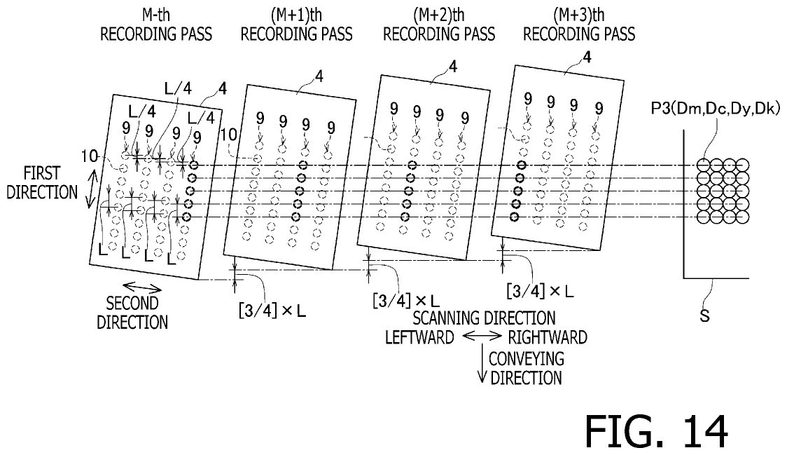

FIG. 13 is a flowchart to illustrate a flow of steps to record an image in the printer shown in FIG. 11.

FIG. 14 is an illustrative view of ink droplets in four colors formed in different recording passes in a multicolor recording process landing on a same position to produce a pixel on a sheet.

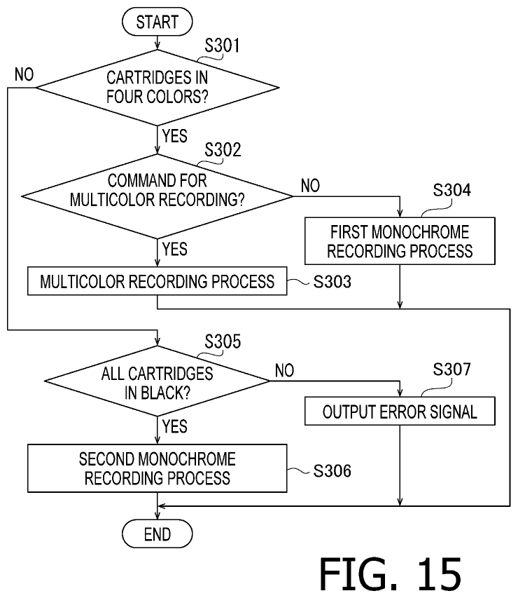

FIG. 15 is a flowchart to illustrate a flow of steps to conduct one of a multicolor recording process and a first monochrome recording process when the printer is capable of discharging inks in four colors, or a second monochrome recording process when the printer is capable of discharging the black ink.

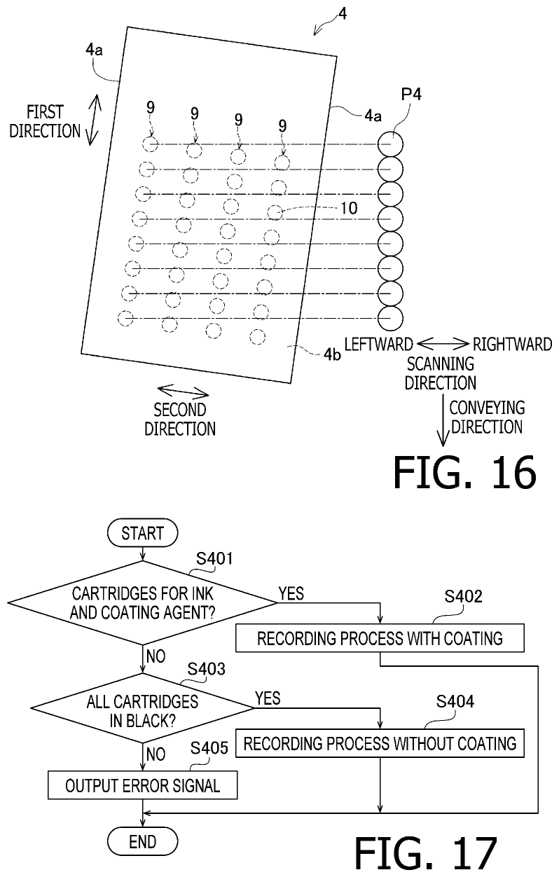

FIG. 16 is an illustrative view of an inkjet head and landing positions in the first monochrome recording process.

FIG. 17 is a flowchart to illustrate a flow of steps to conduct a recording process with coating when coating-agent cartridges are mounted or a recording process without coating when the coating-agent cartridges are not mounted in the printer.

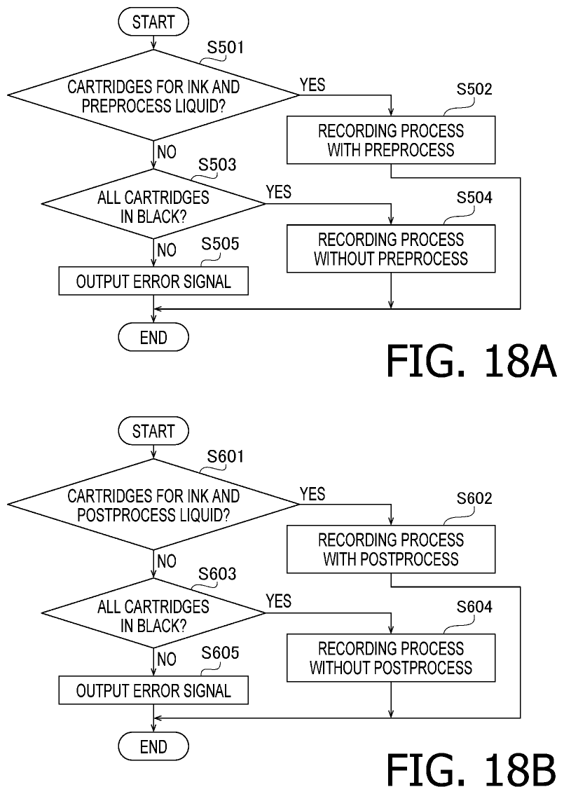

FIG. 18A is a flowchart to illustrate a flow of steps to conduct a recording process with preprocess when preprocess-liquid cartridges are mounted or a recording process without the preprocess when the preprocess-liquid cartridges are not mounted. FIG. 18B is a flowchart to illustrate a flow of steps to conduct a recording process with postprocess when postprocess-liquid cartridges are mounted or a recording process without the postprocess when the postprocess-liquid cartridges are not mounted.

Embodiments of the present disclosure will be described below.

### Overall Configuration of Printer

As shown in FIG. 1, a printer 1 according to the present disclosure includes a carriage 2, a sub tank 3, an inkjet head 4, a platen 5, and conveyer rollers 6, 7. The printer 1 is an example of recording apparatus, and the inkjet head 4 is an example of head.

The carriage 2 is supported by two guide rails 11, 12 extending in a scanning direction. The carriage 2 is connected to a carriage motor 86 (see FIG. 4) through, for example, a belt, which is not shown. When the carriage motor 86 is activated, the carriage 2 may move in the scanning direction along the guide rails 11, 12. In the description below, a right-hand side and a left-hand side in FIG. 1 to a viewer will be called a rightward side and a leftward side, respectively, in the scanning direction.

The sub tank 3 is mounted on the carriage 2. The printer 1 has a cartridge holder 13. The cartridge holder 13 has four cartridge attachable compartments 41, which are aligned in the scanning direction. In each of the cartridge attachable compartments 41, an ink cartridge 14 is detachably attached. To a most leftward one of the cartridge attachable compartments 41 in the scanning direction, an ink cartridge 14 containing black pigment ink may be attached. To the other three of the cartridge attachable compartments 41 on the right in the scanning direction, i.e., a most rightward one, a second rightward one, and a third rightward one of the cartridge attachable compartments 41, ink cartridges 14 containing dye inks in colors of yellow, cyan, magenta, respectively, may be attached. Optionally, to all of the four cartridge attachable compartments 41, the ink cartridges14 containing the black pigment ink may be attached. According to the present embodiment, the ink cartridges 14 are an example of liquid cartridges, the ink cartridge 14 attachable to the most leftward one of the cartridge attachable compartments 41 is an example of first reservoir, and the ink cartridges 14 attachable to the other three cartridge attachable compartments 41 are an example of second reservoir.

As shown in FIG. 2, the cartridge holder 13 has four supply flow paths 42, each of which is connected with one of the four cartridge attachable compartments 41. The four supply flow paths 42 are connected to the sub tank 3 through four tubes 15.

In each ink cartridge 14, an ink reservoir chamber 51 to store the ink is formed. Each ink cartridge 14 has an ink supplying portion 52 located at a lower end of the ink cartridge 14 on an upstream end in a conveying direction, which is a horizontal direction and intersects orthogonally with the scanning direction, when the ink cartridge 14 is attached to the cartridge attachable compartment 41. The ink supplying portion 52 is connected to an ink reservoir chamber 51 when the ink cartridge 14 is attached to the cartridge attachable compartment 41. In the ink supplying portion 52, a valve (not shown) is provided. In a state where the ink cartridge 14 is not attached to the cartridge attachable compartment 41, the valve is closed, and the ink in the ink reservoir chamber 51 may be prevented from leaking outward through the ink supplying portion 52. When the ink cartridge 14 is attached to the cartridge attachable compartment 41, the ink supplying portion 52 is connected with the supply flow path 42, the valve opens, and the ink contained in the ink reservoir chamber 51 may flow into the supply flow path 42 through the ink supplying portion 52. Thus, the inks contained in the ink cartridges 14 may be supplied to the sub tank 3 through the four tubes 15. The conveying direction in the present embodiment is an example of relative-movement direction.

On a surface 14a of each ink cartridge 14 that faces upward when the ink cartridge 14 is attached to the cartridge attachable compartment 41, an IC chip 53 is mounted. The IC chip 53 stores information concerning the ink cartridge 14. The information concerning the ink cartridge 14 includes information concerning a type of the ink, such as a color of the ink, contained in the ink cartridge 14 on which the IC chip 53 is mounted. Meanwhile, on a ceiling 41a of each cartridge attachable compartment 41, a contact portion 43 is arranged. The contact portion 43 is connected to a controller 80, which will be described later. When the ink cartridge 14 is attached to the cartridge attachable compartment 41, the IC chip 53 is connected to the contact portion 43. Thereby, the information concerning the ink cartridge 14 stored in the IC chip 53 may be read and transmitted to the controller 80. The contact portion 43 is an example of information reader.

The inkjet head 4 is mounted on the carriage 2 and connected to a lower end of the sub tank 3. To the inkjet head 4, inks may be supplied from the sub tank 3. The inkjet head 4 has a rectangular exterior shape in a view along a vertical direction. The rectangular-shaped inkjet head 4 has a pair of opposing sides 4a, which extend in a first direction. The first direction is parallel to a plane containing the scanning direction and the conveying direction and intersects with both the scanning direction and the conveying direction.

The inkjet head 4 may discharge the inks from a plurality of nozzles 10 formed through a nozzle surface 4b, which is a downward surface of the inkjet head 4. In particular, as shown in FIGS. 1 and 3, the plurality of nozzles 10 are aligned in the first direction to form four nozzle rows 9, and the four nozzle rows 9 are arrayed along a second direction, which is horizontal and intersects orthogonally with the first direction. Among the four nozzle rows 9, positions of the nozzles 10 in the first direction are the same.

In each nozzle row 9, a plurality of nozzles 10 are aligned in the conveying direction at intervals of a distance L. The positions of the nozzles 10 forming the first through third nozzle rows 9 from the right in the scanning direction are offset toward a downstream side in the conveying direction from the positions of the nozzles 10 in the nozzle row 9 adjoining respectively on the leftward side in the scanning direction by a distance L/4. In this arrangement, the nozzles 10 in the inkjet head 4 are arrayed at intervals of the distance L/4 in the conveying direction.

The four nozzle rows 9 are in one-to-one correspondence with the four cartridge attachable compartments 41. The nozzles 10 forming each nozzle row 9 is continuous with the ink reservoir chamber 51 of the ink cartridge 14 attached to the corresponding one of the cartridge attachable compartments 41 through the tube 15, the flow path in the sub tank 3, and the flow path in the inkjet head 4. Thus, the ink may be supplied from the ink cartridge 14 attached to the cartridge attachable compartment 41 to the nozzles 10 forming the corresponding one of the nozzle rows 9.

In this arrangement, when the four ink cartridges 14 containing the inks in the four colors are attached to the four cartridge attachable compartments 41, the black pigment ink may be discharged from the nozzles 10 forming the most leftward one of the nozzle rows 9 in the scanning direction, and the dye inks in yellow, cyan, magenta may be discharged from the nozzles 10 forming the second leftward one of the nozzle rows 9, the third leftward one of the nozzle rows 9, and the fourth leftward one of the nozzle rows 9, respectively, in the scanning direction. On the other hand, when the four ink cartridges 14 all containing the black pigment ink are attached to the four cartridge attachable compartments 41, the black pigment ink may be discharged from the nozzles 10 forming the four nozzle rows 9. According to the present embodiment, the nozzles 10 forming the most leftward one of the nozzle rows 9 are example of first nozzles, and the nozzles 10 forming the other three nozzle rows 9 on the right are example of second nozzles.

The platen 5 is located below the inkjet head 4 and faces the nozzles 10. The platen 5 extends over an entire length of a recording sheet S in the scanning direction and supports the recording sheet S from below. The conveyer roller 6 is located on an upstream side of the inkjet head 4 and the platen 5 in the conveying direction. The conveyer roller 7 is located on a downstream side of the inkjet head 4 and the platen 5 in the conveying direction. The conveyer rollers 6, 7 are connected to a conveyer motor 87 (see FIG. 4) through gears, and the like, which are not shown. As the conveyer motor 87 is activated, the conveyer rollers 6, 7 may rotate, and the recording sheet S may be conveyed in the conveying direction. Thereby, the inkjet head 4 and the recording sheet S may move relatively in the conveying direction. The conveyer rollers 6, 7 are example of relative-movement device.

### Electric Configuration of Printer

An electric configuration of the printer 1 will be described below. As shown in FIG. 4, the printer 1 has the controller 80. The controller 80 includes a CPU 81, a ROM 82, a RAM 83, a flash memory 84, and an ASIC 85. CPU is an abbreviation of Central Processing Unit, ROM is an abbreviation of Read Only Memory, RAM is an abbreviation of Random Access Memory, and ASIC is an abbreviation of Application Specific Integrated Circuit.

The controller 80 may control actions of devices in the printer 1 including the carriage motor 86, the inkjet head 4, and the conveyer motor 87. Further, the controller 80 may acquire the information concerning the ink cartridges 14 (solely one is shown in FIG. 4) stored in the IC chips 53 (solely one is shown in FIG. 4) through the contact portions 43 (solely one is shown in FIG. 4).

Moreover, the printer 1 includes a display 69 and an operation interface 68. The display 69 may be a liquid crystal display arranged on a housing of the printer 1 and may display information concerning the actions in the printer 1 under the control of the controller 80. The operation interface 68 includes buttons arranged on the housing of the printer 1 and a touch panel arranged in the display 69. When a user operates the operation interface 68, signals corresponding to the operation by the user may be transmitted from the operation interface 68 to the controller 80.

Optionally, the controller 80 may have the CPU 81 alone or the ASIC 85 alone to conduct processes or may have the CPU 81 and the ASIC 85 cooperating with each other to conduct the processes. Optionally, moreover, the controller 80 may have a single CPU 81 that may conduct the processes or may have a plurality of CPUs 81 sharing the processes. Optionally, moreover, the controller 80 may have a single ASIC 85 that may conduct the processes or may have a plurality of ASICs 85 sharing the processes.

### Control in Image Recording

Next, processes to be conducted by the controller 80 when the printer 1 records an image on the recording sheet S will be described. When the controller 80 receives a recording command to instruct the printer 1 to record an image on the recording sheet S, the controller 80 may follow steps in the flowchart shown in FIG. 5 to operate the printer 1 to record the image on the recording sheet S. The recording command may be input in the controller 80 based on the user's operation to, for example, the operation interface 68 or a PC (not shown) connected to the printer 1.

As shown in FIG. 5, when the controller 80 receives a recording command, the controller 80 determines whether the ink cartridges 14 containing the inks in the four colors are attached to the four cartridge attachable compartments 41 (S101). The controller 80 may determine whether the ink cartridges 14 containing the inks in the four colors are attached to the four cartridge attachable compartments 41 based on the information acquired from the IC chips 53 in the ink cartridges 14 attached to the cartridge attachable compartments 41 through the contact portions 43 in the cartridge attachable compartments 41.

If the controller 80 determines that the ink cartridges 14 containing the inks in the four colors are attached to the four cartridge attachable compartments 41 (S101: YES), the controller 80 conducts a multicolor recording process (S102), and the flow ends thereat. The multicolor recording process will be described later.

If the controller 80 determines that the ink cartridges 14 containing the inks in the four colors are not attached to the four cartridge attachable compartments 41 (S101: NO), the controller 80 determines whether the ink cartridges 14 all containing the ink in the black pigment ink are attached to the cartridge attachable compartments 41 (S103). The controller 80 may determine whether the ink cartridges 14 all containing the black pigment ink are attached to the four cartridge attachable compartments 41 based on the information acquired from the IC chips 53 in the ink cartridges 14 attached to the cartridge attachable compartments 41 through the contact portions 43 in the cartridge attachable compartments 41.

If the controller 80 determines that the ink cartridges 14 all containing the ink in the black pigment ink are attached to the cartridge attachable compartments 41 (S103: YES), the controller 80 conducts a monochrome recording process (S104), and the flow ends thereat. The monochrome recording process will be described later.

If the controller 80 determines whether the ink cartridges 14 all containing the ink in the black pigment ink are not attached to the cartridge attachable compartments 41 (S103: NO), the controller 80 outputs an error signal that produces an error message, and the like, to the display 69 or the PC connected to the printer 1 (S105), and the flow ends thereat.

### Multicolor Recording Process and Monochrome Recording Process

Next, the multicolor recording process and the monochrome recording process will be described. In either the multicolor recording process or the monochrome recording process, the controller 80 may cause the printer 1 to record an image by repeating a set of a recording pass, in which the controller 80 controls the carriage motor 86 to move the carriage 2 in the scanning direction and the inkjet head 4 to discharge the ink(s) through the nozzles 10, and a conveying action, in which the controller 80 controls the conveyer motor 87 to rotate the conveyer rollers 6, 7 to convey the recording sheet S. In a recording pass in the multicolor recording process, the inks in the four colors may be discharged from the nozzles 10, and in a recording pass in the monochrome recording process, the ink in black may be discharged from the nozzles 10.

In each recording pass in the multicolor recording process, while N represents a natural number smaller than or equal to a number of the nozzles 10 forming each nozzle row 9, as shown in FIG. 6A, the controller 80 may control the inkjet head 4 to discharge droplets of the inks in black, yellow, cyan, and magenta to form dots Dk, Dy, Dc, Dm in the colors of black, yellow, cyan, and magenta, respectively, in an arrangement such that the droplets of the inks in the colors of black, yellow, cyan, and magenta discharged from the N-th nozzles 10 from the upstream side in the conveying direction in the four nozzle rows 9 are aimed at a spot on the recording sheet S to overlap one another to form a pixel P1 on the recording sheet S. Thus, the multicolor recording of an image to record an image in the inks in the four colors may be conducted.

On the other hand, in each recording pass in the monochrome recording process, as shown in FIG. 6B, the controller 80 may control the inkjet head 4 to discharge the black ink to form four dots in the color of black in an arrangement such that the four droplets of the black discharged from the four N-th nozzles 10 from the upstream side in the conveying direction in the four nozzle rows 9 are aimed at different spots to land without overlapping one another on the recording sheet S to form four (4) different pixels P2. Thus, monochrome recording of an image in the ink in the single color of black may be conducted. In this arrangement, a resolution of the image in the conveying direction recorded in the monochrome recording process is four times higher than a resolution of the image in the conveying direction recorded in multicolor recording.

Meanwhile, an amount of the ink discharged from each nozzle 10 in the recording pass in the monochrome recording process is smaller than or equal to an amount of the ink discharged from each nozzle 10 in the recording pass in the multicolor recording process. Therefore, a size of each dot, i.e., the pixel P2, formed in the recording pass in the monochrome recording process is smaller than or equal to a size of each of the dots Dk, Dy, Dc, Dm formed in the recording pass in the multicolor recording process.

### Benefits

According to the present embodiment described above, the positions of the nozzles 10 in the scanning direction and the conveying direction differ from one another among the four nozzle rows 9. Moreover, within a range in the conveying direction between a most upstream one of the nozzles 10 and a second upstream one of the nozzles 10 in the most leftward one of the nozzle rows 9 in the scanning direction, one of the nozzles 10 forming the second leftward one of the nozzle rows 9, one of the nozzles 10 forming the third leftward one of the nozzle rows 9, and one of the nozzles forming the fourth leftward one of the nozzle rows 9 are located.

Therefore, when the ink cartridge 14 containing the black pigment ink is attached to the most leftward one of the cartridge attachable compartments 41 in the scanning direction, and when the ink cartridges 14 containing the multicolored dye inks are attached to the other three cartridge attachable compartments 41 on the right in the scanning direction, by controlling the inkjet head 4 to discharge the inks in the four colors from the nozzles 10 forming the four nozzle rows 9, the printer 1 may record a multicolored image. On the other hand, when the ink cartridges 14 all containing the black pigment ink are attached to the four cartridge attachable compartments 41, by controlling the inkjet head 4 to discharge the ink in black from the nozzles 10 forming the four nozzle rows 9, the printer 1 may record a monochrome image. Moreover, when recording an image in monochrome recording, the resolution of the image in the conveying direction recorded in a single recording pass may be increased compared to the resolution of the image recorded in multicolor recording.

Moreover, according to the present embodiment, among the four nozzle rows 9, the nozzles 10 are located at the same positions in the first direction, in which the nozzles 10 are aligned. Therefore, by setting the first direction to be parallel to the plane containing the scanning direction and the conveying direction and to intersect with the scanning direction and the conveying direction, the positions of the nozzles 10 in the conveying direction may be offset among the four nozzle rows 9.

Moreover, according to the present embodiment, the inkjet head 4 has the rectangular shape in the view along the vertical direction, and the nozzles 10 forming the nozzle rows 9 are aligned in parallel to the opposing sides 4a of the rectangle. Therefore, by setting the inkjet head 4 in an arrangement such that the opposing sides 4a incline with respect to the scanning direction and the conveying direction, the first direction, in which the nozzles 10 forming the nozzle rows 9 are aligned, may be set to the direction parallel to the plane containing the scanning direction and the conveying direction and intersecting with the scanning direction and the conveying direction.

Moreover, according to the present embodiment, an amount of the ink discharged from each nozzle 10 in the recording pass in the monochrome recording process is smaller than or equal to an amount of the ink discharged from each nozzle 10 in the recording pass in the multicolor recording process. Further, a size of each dot formed in the recording pass in the monochrome recording process is smaller than or equal to a size of each of the dots Dk, Dy, Dc, Dm formed in the recording pass in the multicolor recording process. Therefore, images may be recorded preferably to either the monochrome recording process or the multicolor recording process.

Moreover, according to the present embodiment, in the multicolor recording process, the pixel P1 may consist of the four dots Dk, Dy, Dc, Dm, which are formed of the four droplets of the inks discharged from the four nozzles 10 in the different nozzle rows 9 and overlap one another. Thereby, the multicolored image may be recorded. On the other hand, in the monochrome recording process, the pixels P2 may consist of the dots, which are formed of the droplets of the ink discharged from the nozzles 10 in the different nozzle rows 9 not overlapping one another. Therefore, a resolution of the image in the conveying direction in each recording pass in the monochrome recording process may be increased compared to a resolution of the image in the conveying direction in each recording pass in the multicolor recording process.

Moreover, according to the present embodiment, the monochrome recording process or the monochrome recording process may be conducted correctly based on the information read from the IC chips 53 on the ink cartridges 14.

### Modified Examples

While the invention has been described in conjunction with various example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

For example, the direction to array the nozzles 10 that form the nozzle rows 9 in the inkjet head 4, the exterior shape of the inkjet head 4, and/or the relationship among the nozzles 10, the nozzle rows 9, and the exterior shape of the inkjet head 4 may not necessarily be limited to those described above in the embodiment.

A first modified example will be described below with reference to FIG. 7. As shown in FIG. 7, an inkjet head 101 has a rectangular exterior shape in a view along the vertical direction, and the nozzles 10 forming the nozzle rows 9 are aligned in a direction, in which opposing sides 101a of the rectangle extend. The inkjet head 101 is in an arrangement such that the opposing sides 101a extend in parallel to the conveying direction. According to the first modified example, the conveying direction is an example of the relative-movement direction and of the aligned direction.

The nozzles 10 forming each of the nozzle rows 9 are aligned in the conveying direction at intervals of the distance L. The positions of the nozzles 10 forming the first through third nozzle rows 9 from the right in the scanning direction are offset toward the downstream side in the conveying direction from the positions of the nozzles 10 in the nozzle row 9 adjoining respectively on the leftward side in the scanning direction by the distance L/4. Therefore, the positional relation among the nozzles 10 within the inkjet head 101 is equal to the positional relation among the nozzles 10 in the inkjet head 4 in the embodiment described above.

A second modified example will be described with reference to FIG. 8A. As shown in FIG. 8A, an inkjet head 110 consists of two head units 111, 112. The head unit 111 has a rectangular exterior shape having a pair of opposing sides 111a, which are parallel to the first direction, in a view along the vertical direction. The head unit 111 has a nozzle row 9, and the nozzles 10 forming the nozzle row 9 are aligned in the first direction, in which the opposing sides 111a of the rectangle extend.

The head unit 112 has a rectangular exterior shape having a pair of opposing sides 112a, which are parallel to the first direction, in the view along the vertical direction. The head unit 112 has three nozzle rows 9, and the nozzles 10 forming each nozzle row 9 are aligned in the first direction, in which the opposing sides 112a extend. Positions of the nozzles 10 in the first direction are the same among the three nozzle rows 9.

The nozzles 10 forming each of the nozzle rows 9 in the head units 111, 112 are aligned in the conveying direction at intervals of the distance L. The positions of the nozzles 10 forming the most leftward one of the nozzle rows 9 in the scanning direction in the head unit 112 are offset toward the downstream side in the conveying direction from the nozzles 10 in the nozzle row 9 in the head unit 111 by the distance L/4. Moreover, the positions of the nozzles 10 forming the first and second nozzle rows 9 from the right in the scanning direction in the head unit 112 are offset toward the downstream side in the conveying direction from the nozzles 10 in the nozzle row 9 respectively adjoining on the leftward side in the scanning direction by the distance L/4. Therefore, the positional relation among the nozzles 10 in the four nozzle rows 9, which include the nozzles 10 in the nozzle row 9 in the head unit 111 and the nozzles 10 in the three nozzle rows 9 in the head unit 112, within the inkjet head 110 is equal to the positional relation among the nozzles 10 in the inkjet head 4 in the embodiment described above.

A third modified example will be described with reference to FIG. 8B. As shown in FIG. 8B, an inkjet head 120 consists of two head units 121, 122. The head unit 121 is in the same structure as the head unit 111 in the second modified example; however, the head unit 121 is in an arrangement such that opposing sides 121a extend in parallel to the conveying direction.

The head unit 122 has a rectangular exterior shape having a pair of opposing sides 122a, which are parallel to the conveying direction, in a view along the vertical direction. The head unit 122 has three nozzle rows 9, and the nozzles 10 forming each nozzle row 9 are aligned in the conveying direction, in which the opposing sides 122a extend.

The nozzles 10 forming each of the nozzle rows 9 in the head units 121, 122 are aligned in the conveying direction at intervals of the distance L. The positions of the nozzles 10 forming the most leftward one of the nozzle rows 9 in the scanning direction in the head unit 122 are offset toward the downstream side in the conveying direction from the positions of the nozzles 10 in the nozzle row 9 in the head unit 121 by the distance L/4. Moreover, the positions of the nozzles 10 forming the first and second nozzle rows 9 from the right in the scanning direction in the head unit 122 are offset toward the downstream side in the conveying direction from the nozzles 10 in the nozzle row 9 respectively adjoining on the leftward side in the scanning direction by the distance L/4. Therefore, the positional relation among the nozzles 10 in the four nozzle rows 9, which include the nozzles 10 in the nozzle row 9 in the head unit 121 and the nozzles 10 in the three nozzle rows 9 in the head unit 122, within the inkjet head 120 is equal to the positional relation among the nozzles 10 in the inkjet head 4 in the embodiment described above.

A fourth modified example will be described with reference to FIG. 9A. As shown in FIG. 9A, an inkjet head 130 consists of four head units 131-134. The head units 131-134 are each in the same structure as the head unit 111 in the second modified example. The head units 131-134 are in an arrangement such that opposing sides 131a-134a extend in parallel to the first direction and arrayed side by side along the second direction. Positions of the nozzles 10 in the first direction are the same among the four nozzle rows 9 in the four head units 131-134.

The nozzles 10 forming each of the nozzle rows 9 in the head units 131-134 are aligned in the conveying direction at intervals of the distance L. The nozzles 10 forming the nozzle rows 9 in the head units 132-134 are offset toward the downstream side in the conveying direction from the nozzles 10 in the nozzle row 9 in the head units 131-133 respectively adjoining on the leftward side in the scanning direction by the distance L/4. Therefore, the positional relation among the nozzles 10 in the four nozzle rows 9, which include the nozzles 10 in the nozzle rows 9 in the head units 131-134, within the inkjet head 130 is equal to the positional relation among the nozzles 10 in the inkjet head 4 in the embodiment described above.

A fifth modified example will be described with reference to FIG. 9B. As shown in FIG. 9B, an inkjet head 140 consists of four head units 141-144. The head units 141-144 are each in the same structure as the head unit 121 in the third modified example. The head units 141-144 are in an arrangement such that opposing sides 141a-144a extend in parallel to the conveying direction and arrayed side by side along the scanning direction.

The nozzles 10 forming each of the nozzle rows 9 in the head units 141-144 are aligned in the conveying direction at intervals of the distance L. The head units 142-144 are offset toward the downstream side in the conveying direction from the head units 141-143 respectively adjoining on the leftward side in the scanning direction by the distance L/4. Therefore, the positional relation among the nozzles 10 in the four nozzle rows 9, which include the nozzles 10 in the nozzle rows 9 in the head units 141-144, within the inkjet head 140 is equal to the positional relation among the nozzles 10 in the inkjet head 4 in the embodiment described above.

A sixth modified example will be described with reference to FIG. 10A. As shown in FIG. 10A, an inkjet head 150 consists of two head units 151, 152. The head units 151, 152 are in the same structure. Each of the head units 151, 152 has a rectangular exterior shape having a pair of opposing sides 151a, 152a, respectively, which extend in parallel to the first direction, in a view along the vertical direction. Each of the head units 151, 152 has two nozzle rows 9, and the nozzles 10 forming each nozzle row 9 are aligned in the first direction, in which the opposing sides 151a, 152a of the rectangles extend. Positions of the nozzles 10 in the first direction are the same among the four nozzle rows 9 including the two nozzle rows 9 in the head unit 151 and the two nozzle rows 9 in the head unit 152.

The nozzles 10 forming each of the nozzle rows 9 in the head units 151, 152 are aligned in the conveying direction at intervals of the distance L. The nozzles 10 forming the nozzle rows 9 on the right in the scanning direction in the head units 151, 152 are offset toward the downstream side in the conveying direction from the nozzles 10 in the nozzle rows 9 on the left in the head units 151, 152 by the distance L/4. Moreover, the positions of the nozzles 10 forming the nozzle row 9 on the left in the head unit 152 in the scanning direction are offset toward the downstream side in the conveying direction from the nozzles 10 in the nozzle row 9 on the right in the head unit 151 in the scanning direction by the distance L/4. Therefore, the positional relation among the nozzles 10 in the four nozzle rows 9, which include the nozzles 10 in the two nozzle rows 9 in the head unit 151 and the nozzles 10 in the two nozzle rows 9 in the head unit 152, is equal to the positional relation among the nozzles 10 in the inkjet head 4 in the embodiment described above.

A seventh modified example will be described with reference to FIG. 10B. As shown in FIG. 10B, an inkjet head 160 consists of two head units 161, 162.

The head units 161, 162 are in the same structure. Each of the head units 161, 162 has a rectangular exterior shape having a pair of opposing sides 161a, 162a, respectively, which extend in parallel to the conveying direction, in a view along the vertical direction. Each of the head units 161, 162 has two nozzle rows 9, and the nozzles 10 forming each nozzle row 9 are aligned in the conveying direction, in which the opposing sides 161a, 162a of the rectangles extend.

The nozzles 10 forming each of the nozzle rows 9 in the head units 161, 162 are aligned in the conveying direction at intervals of the distance L. The nozzles 10 forming the nozzle rows 9 on the right in the scanning direction in the head units 161, 162 are offset toward the downstream side in the conveying direction from the nozzles 10 in the nozzle rows 9 on the left in the scanning direction in the head units 161, 162 by the distance L/4. Moreover, the head unit 162 is offset toward the downstream side in the conveying direction from the head unit 161 by a distance L/2; thereby, the nozzles 10 forming the nozzle row 9 on the left in the head unit 162 in the scanning direction are offset toward the downstream side in the conveying direction from the nozzles 10 in the nozzle row 9 on the right in the head unit 161 in the scanning direction by the distance L/4. Therefore, the positional relation among the nozzles 10 in the four nozzle rows 9, which include the nozzles 10 in the two nozzle rows 9 in the head unit 161 and the nozzles 10 in the two nozzle rows 9 in the head unit 162, within the inkjet head 160 is equal to the positional relation among the nozzles 10 in the inkjet head 4 in the embodiment described above.

Meanwhile, for example, the direction, in which the opposing sides of the rectangles forming the outlines of the inkjet heads or the head units, may not necessarily extend in parallel to the direction, in which the nozzles 10 forming the nozzle rows 9 are aligned, such as those in the embodiment and the first through seventh modified examples described above. Moreover, the inkjet heads or the head units may not necessarily have the rectangular exterior shapes but may have different exterior shapes.

For another example, the inkjet head may not necessarily have four nozzle rows 9 such as those in the embodiment and the first through seventh modified examples described above but may have, for example, two, three, five or more nozzle rows 9.

For another example, the inks may not necessarily be stored in the ink cartridges 14 attached to the cartridge attachable compartments 41 to be supplied to the inkjet head 4 such as those in the embodiment and the first through seventh modified examples described above, or the controller 80 may not necessarily conduct one of the multicolor recording process and the monochrome recording process based on the information concerning the ink cartridges 14 acquired from the IC chips 53 attached to the ink cartridges 14.

An eighth modified example will be described with reference to FIGS. 11-13. As shown in FIG. 11, a printer 200 has four ink tanks 201 in place of the cartridge holder13 and the ink cartridges 14 in the printer 1 in the embodiment described above.

As shown in FIG. 12, in each ink tank 201, an ink reservoir chamber 211 to store ink is formed. The ink tank 201 has an ink supplying portion 212, which connects an ink reservoir chamber 211 with the tube 15. The ink supplying portion 212 is located at a lower end on an upstream end of the ink tank 201 in the conveying direction. Moreover, the ink tank 201 has an ink-refilling port 213 at an upper position in the ink tank 201, and the ink reservoir chamber 211 may be refilled with the ink through the ink-refilling port 213. Further, a cap 214 to close the ink-refilling port 213 is detachably attached to the ink tank 201.

Processes to be conducted by the controller 80 for recording an image in the printer 200 will be described below. In the printer 200, the flash memory 84 stores recording-mode information indicating a recording mode, in which the printer 200 is operable, among a multicolor recording mode and a monochrome recording mode. The recording-mode information may be stored in the flash memory 84 according to an operation to the operation interface 68 when, for example, the printer 200 is manufactured, or the printer 200 is used initially.

When the printer 200 is to be used under a condition where the ink reservoir chamber 211 in the most leftward one of the ink tanks 201 in the scanning direction contains the black pigment ink, and the second, third, and fourth ink tanks 201 from the left in the scanning direction contain the dye inks in the colors of yellow, cyan, magenta, respectively, the recording-mode information indicating that the printer 200 will operate in the multicolor recording mode is stored in the flash memory 84. On the other hand, when the printer 200 is to be used under a condition where the ink reservoir chambers 211 in all of the four ink tanks 201 contain the black pigment ink, the recording-mode information indicating that the printer 200 will operate in the monochrome recording mode is stored in the flash memory 84.

According to the eighth modified example, the operation interface 68 is an example of selection-signal receiver, and a signal, which is received by the operation interface 68 when the operation interface 68 is operated, to cause the flash memory 84 to store the recording-mode information is an example of selecting signal.

When the controller 80 in the printer 200 receives a recording command, the controller 80 may follow steps in the flowchart shown in FIG. 13. As shown in FIG. 13, the controller 80 determines whether the recording-mode information stored in the flash memory 84 indicates an image is to be recorded in the multicolor recording mode (S201). If the recording-mode information indicates the image is to be recorded in the multicolor recording mode (S201: YES), the controller 80 conducts the multicolor recording process (S202), similarly to S102 (see FIG. 5) in the embodiment described above. If the recording-mode information does not indicate the image is to be recorded in the multicolor recording mode (S201: NO), the controller 80 conducts the monochrome recording process (S203), similarly to S104 (see FIG. 5) in the embodiment described above.

According to the eighth modified example, optionally, the printer 200 may record a multicolored image by storing the black pigment ink in the most leftward one of the ink tanks 201 in the scanning direction and storing the dye inks in the multiple colors in the other three ink tanks 201 on the right in the scanning direction, and by controlling the inkjet head 4 to discharge the inks in the four colors from the nozzles 10 forming the four nozzle rows 9. Alternatively, the printer 200 may record a monochrome image by storing the black pigment ink in all of the four ink tanks 201 and by controlling the inkjet head 4 to discharge the black ink from the nozzles 10 forming the four nozzle rows 9. Moreover, when recording an image in monochrome recording, the resolution of the image in the conveying direction to be recorded in a single recording pass may be higher than the resolution of the image recorded in multicolor recording.

Moreover, according to the eighth modified example, the flash memory 84 stores the recording-mode information indicating the recording mode among the multicolor recording mode and the monochrome recording mode in which the printer 200 may operate. Based on the recording-mode information stored in the flash memory84, the printer 200 may record an image in multicolor recording process or the monochrome recording process. Therefore, for example, the printer 200 may be used as a multicolor image printer or a monochrome image printer depending on a selection of a manufacturer or a user of the printer 200.

Moreover, in the case where the inks are supplied from the ink cartridges 14 to the inkjet head 4 in the embodiment as described above, similarly to the eighth modified example, the recording-mode information indicating the recording mode among the multicolor recording mode and the monochrome recording mode in which the printer may operate may be stored in the flash memory 84. Based on the recording-mode information stored in the flash memory84, the printer 1 may record an image in the multicolor recording process or the monochrome recording process.

In the embodiment described above, the positions of the nozzles 10 in the conveying direction are offset from one another among the four nozzle rows 9, and the four dots Dk, Dy, Dc, Dm formed in a single recording pass may form a single pixel P1 when the image is recorded in the multicolor recording process. Therefore, the positions of the four dots Dk, Dy, Dc, Dm forming the single pixel P1 are offset from one another in the conveying direction. However, the positions of the four dots Dk, Dy, Dc, Dm forming the single pixel P1 may not necessarily be offset from one another in the conveying direction.

A ninth modified example will be described below with reference to FIG. 14. As shown in FIG. 14, when an image is recorded in the multicolor recording process, in an M-th recording pass, the ink in magenta may be discharged from the nozzles 10 forming the most rightward one of the nozzle rows 9 in the scanning direction to form dots Dm in magenta on the recording sheet S. In FIG. 14, the nozzles 10 that discharge the ink in the recording pass are drawn in thicker circles.

After the recording pass, the controller 80 controls the conveyer rollers 6, 7 to convey the recording sheet P by a distance (3/4)*L and, in an (M+1)th recording pass, the controller 80 controls the inkjet head 4 to discharge the ink in cyan from the nozzles 10 forming the second one of the nozzle rows 9 from the right in the scanning direction to form dots Dc in cyan. The positions of the cyan-colored dots Dc in the scanning direction and the conveying direction formed in the (M+1)th recording pass are the same as the positions of the magenta-colored dots Dm in the scanning direction and the conveying direction formed in the M-th recording pass. It may be noted that in FIG. 14, for easier understanding, the inkjet head 4 is illustrated at the positions offset toward the upstream side in the conveying direction by the distance (3/4)*L to express the recording sheet S having been conveyed in the conveying direction by the distance (3/4)*L.

Thereafter, the controller 80 controls the conveyer rollers 6, 7 to convey the recording sheet P by the distance (3/4)*L and, in an (M+2)th recording pass, the controller 80 controls the inkjet head 4 to discharge the ink in yellow from the nozzles 10 forming the third one of the nozzle rows 9 from the right in the scanning direction to form dots Dy in yellow. The positions of the yellow-colored dots Dy in the scanning direction and the conveying direction formed in the (M+2)th recording pass are the same as the positions of the magenta-colored dots Dm formed in the M-th recording pass and the cyan-colored dots Dc formed in the (M+1)th recording pass in the scanning direction and the conveying direction.

Thereafter, the controller 80 controls the conveyer rollers 6, 7 to convey the recording sheet P by the distance (3/4)*L and, in an (M+3)th recording pass, the controller 80 controls the inkjet head 4 to discharge the ink in black from the nozzles 10 forming the most leftward one of the nozzle rows 9 in the scanning direction to form dots Dk in black. The positions of the black-colored dots Dk in the scanning direction and the conveying direction formed in the (M+3)th recording pass are the same as the positions of the magenta-colored dots Dm formed in the M-th recording pass, the cyan-colored dots Dc formed in the (M+1)th recording pass, and the yellow-colored dots Dy formed in the (M+2)th recording pass in the scanning direction and the conveying direction. Thus, pixels P3, in each of which the four-colored dots Dm Dc, Dy, Dk overlap one another at the same position in the scanning direction and the conveying direction, may be formed.

According to the ninth modified example, the printer 1 likewise may record a multicolored image by attaching the ink cartridge 14 containing the black pigment ink to the most leftward one of the cartridge attachable compartments 41 in the scanning direction and attaching the ink cartridges 14 containing the multicolored dye inks to the other three cartridge attachable compartments 41 on the right in the scanning direction, and by controlling the inkjet head 4 to discharge the inks in the four colors from the nozzles 10 forming the four nozzle rows 9. Alternatively, the printer 1 may record an image in monochrome recording by attaching the four ink cartridges 14 all containing the black pigment ink to the four cartridge attachable compartments 41 and by controlling the inkjet head 4 to discharge the black ink from the nozzles 10 forming the four nozzle rows 9. Moreover, when recording an image in monochrome recording, the resolution of the image in the conveying direction recorded in a single recording pass may be higher than the resolution of an image recorded in multicolor recording.

Moreover, according to multicolor recording in the ninth modified example, four dots Dk, Dy, Dc, Dm, which are formed in the inks discharged from the four nozzles 10 forming the different nozzle rows 9, may form a pixel P3, and therefore, pixels, in each of which the four dots Dk, Dy, Dc, Dm overlap one another to produce a desired color, may be formed.

Moreover, according to multicolor recording in the ninth modified example, a pixel may be formed by placing a dot, which is formed in the ink discharged from one of the nozzles 10 forming one of the nozzle rows 9 in one recording pass, and dots, which are formed in the inks discharged from another nozzles 10 forming another nozzle rows 9 in another recording passes, to overlap one another. Therefore, by adjusting an amount to convey the recording sheet S in each conveying action, the dots forming the same pixel may be located at the same position in the conveying direction even though the positions of the nozzles 10 in the conveying direction are different among the nozzle rows 9. Accordingly, a quality of the image recorded in the multicolor recording process may be improved compared to a quality of an image, in which positions of dots to form each pixel are offset to partly overlap one another in the conveying direction.

According to the ninth modified example, the pixel P3 may be formed of the four dots Dk, Dy, Dc, Dm formed in the four consecutive recording passes to overlap one another. However, a pixel may not necessarily be formed of four dots formed in four consecutive recording passes but may be formed of four dots Dk, Dy, Dc, Dm formed to overlap one another in four nonconsecutive recording passes.

According to the embodiment described above, the image may be recorded in multiple colors at all time when the ink cartridges 14 containing the inks in the four colors are attached to the four cartridge attachable compartments 41. However, the image may not necessarily be recorded in multiple colors at all time when the ink cartridges 14 containing the inks in the four colors are attached to the four cartridge attachable compartments 41. For example, according to a tenth modified example, the recording command may contain information indicating which one of multicolor recording and monochrome recording the printer 1 should conduct to record an image.

The tenth modified example will be described below with reference to FIG. 15. As shown in FIG. 15, if the ink cartridges 14 containing the inks in the four colors are attached to the four cartridge attachable compartments 41 (S301: YES), the controller 80 determines whether the recording command indicates that multicolor recording is to be conducted (S302). If the recording command indicates that multicolor recording is to be conducted (S302: YES), the controller 80 conducts the multicolor recording process (S303) similarly to S102 (see FIG. 5). If the recording command indicates that monochrome recording is to be conducted (S302: NO), the controller conducts a first monochrome recording process (S304), which will be described below.

If the ink cartridges 14 containing the inks in the four colors are not attached to the four cartridge attachable compartments 41 (S301: NO), the controller 80 determines whether the ink cartridges 14 all containing the black ink are attached to the four cartridge attachable compartments 41 (S305). If the ink cartridges 14 all containing the black ink are attached to the four cartridge attachable compartments 41 (S305: YES), the controller 80 conducts a second monochrome recording process (S306), which is the same process as the monochrome recording process in S104 (see FIG. 5) in the embodiment described above.

If the ink cartridges 14 all containing the black ink are not attached to the four cartridge attachable compartments 41 (S305: NO), the controller 80 outputs an error signal that produces an error message, and the like, to the display 69 or the PC (not shown) connected to the printer 1 (S307), and the flow ends thereat.

The first monochrome recording process will be described herein. In the first monochrome recording process, similarly to the multicolor recording process described above, the controller 80 may cause the printer 1 to record an image by repeating the set of the recording pass and the conveying action. Meanwhile, in the recording passes in the first monochrome recording process, the controller 80 controls the inkjet head 4 to discharge the black ink from the nozzles 10 forming the most leftward one of the nozzle rows 9 in the scanning direction and not to discharge the inks from the nozzles 10 forming the other three nozzle rows 9 on the right in the scanning direction. Thereby, an image, in which each pixel P4 (see FIG. 16) is formed of a single dot in black, may be recorded in the first monochrome recording process.

According to the tenth modified example, the ink cartridge 14 containing the black pigment ink is attached to the most leftward one of the cartridge attachable compartments 41 in the scanning direction, and the ink cartridges 14 containing the dye inks in the three colors are attached to the other three cartridge attachable compartments 41 on the right in the scanning direction. The printer 1 may conduct the first monochrome recording process by controlling the inkjet head 4 to discharge the black ink from the nozzles 10 forming the most leftward one of the nozzle rows 9 in the scanning direction but not to discharge the inks from the nozzles 10 forming the other three nozzle rows 9 on the right in the scanning direction. Meanwhile, optionally, the printer 1 may have the four ink cartridges 14 all containing the black pigment ink attached to the four cartridge attachable compartments 41, and by controlling the inkjet head 4 to discharge the black ink from the nozzles 10 forming the four nozzle rows 9, the printer 1 may conduct the second monochrome recording process. Moreover, the resolution of the image in the conveying direction recorded in each recording pass in the second monochrome recording process may be higher than the resolution of the image in the conveying direction recorded in each recording pass in the first monochrome recording process.

In the embodiment and the modified examples described above, in the case where the ink cartridges 14 containing the inks in the four colors are not attached to the four cartridge attachable compartments 41 and where the ink cartridges 14 all containing the black ink are not attached to the four cartridge attachable compartments 41, the controller 80 may output the error signal that produces an error message, and the like, to the display 69 or the PC (not shown) connected to the printer 1, and the flow may end thereat. However, the flow may not necessarily be limited to those described above. For example, in the case where the ink cartridges 14 containing the inks in the four colors are not attached to the four cartridge attachable compartments 41 and where the ink cartridges 14 all containing the black ink are not attached to the four cartridge attachable compartments 41, the printer 1 may conduct single-color recording by controlling the inkjet head 4 to discharge the ink in a single color contained in any of the ink cartridge(s) 14 attached to the cartridge-attachable compartment(s) 41 from the nozzles 10 forming one of the nozzle rows 9.

For another example, the black ink may not necessarily be limited to the pigment ink, or the colored inks may not necessarily be limited to the dye inks. For example, the black ink may be a dye ink, and the colored inks may be pigment inks.

For another example, the amount of the ink to be discharged from the nozzles 10 in a recording pass in the monochrome recording process may not necessarily be smaller than or equal to the amount of the ink to be discharged from the nozzles 10 in a recording pass in the multicolor recording process, but smallness or largeness relation among the amount of the ink to be discharged from the nozzles 10 in the recording pass in the monochrome recording process and the amount of the inks to be discharged from the nozzles 10 in the recording pass in the multicolor recording process may be different from that in the embodiment described above. Moreover, the size of a dot, e.g., pixel P1, formed in the recording pass in the monochrome recording process may not necessarily be smaller than or equal to the size of a dot Dk, Dy, Dc, or Dm formed in the recording pass in the multicolor recording process, but smallness or largeness relation among the size of the dot, e.g., pixel P1, formed in the recording pass in the monochrome recording process and the size of the dot Dk, Dy, Dc, or Dm formed in the recording pass in the multicolor recording process may be different from that in the embodiment described above.

For another example, the printer 1 may not necessarily be used with the four ink cartridges 14 containing the inks in the four colors attached to the four cartridge attachable compartments 41 or with the four ink cartridges all containing the black ink attached to the four cartridge attachable compartments 41.

An eleventh modified example will be described herein. In the eleventh modified example, two of the ink cartridges 14 containing the black ink are attached to the most leftward one of the cartridge attachable compartments 41 and the second one of the cartridge attachable compartments 41 from the right in the scanning direction. To the second one of the cartridge attachable compartments 41 from the left and the most rightward one of the cartridge attachable compartments 41 in the scanning direction, coating-agent cartridges containing a coating agent are attached. In this arrangement, the black ink may be discharged from the nozzles 10 forming the most leftward one of the nozzle rows 9 and the second one of the nozzle rows 9 from the right in the scanning direction, and the coating agent may be discharged from the nozzles 10 forming the second one of the nozzle rows 9 from the left and the most rightward one of the nozzle rows 9 in the scanning direction. Moreover, in the eleventh modified example, the four ink cartridges 14 all containing the black ink may optionally be attached to the four cartridge attachable compartments 41, similarly to the embodiment and the modified examples described above. In this arrangement, the black ink may be discharged from all of the nozzles 10.

The ink cartridges 14 attached to the most leftward one of the cartridge attachable compartments 41 and the second one of the cartridge attachable compartments 41 from the right in the scanning direction are an example of first reservoir section. The ink cartridges 14 and the coating-agent cartridges attached to the second one of the cartridge attachable compartments 41 from the left and the most rightward one of the cartridge attachable compartments 41 in the scanning direction are an example of second reservoir section. The nozzles 10 forming the most leftward one of the nozzle rows 9 and the second one of the nozzle rows 9 from the right are an example of first nozzles, and the nozzles 10 forming the second one of the nozzle rows 9 from the left and the most rightward one of the nozzle rows 9 are an example of second nozzles.

In the eleventh modified example, the controller 80 may start a flow in a flowchart shown in FIG. 17 when the controller 80 receives a recording command. As shown in FIG. 17, the controller 80 determines whether the ink cartridges 14 containing the black ink are attached to the most leftward one of the cartridge attachable compartments 41 and the second one of the cartridge attachable compartments 41 from the right in the scanning direction, and the coating-agent cartridges containing the coating agent are attached to the second one of the cartridge attachable compartments 41 from the left and the most rightward one of the cartridge attachable compartments 41 (S401).

If the ink cartridges 14 containing the black ink and the coating agent are attached to the four cartridge attachable compartments 41 in the arrangement described above (S401: YES), the controller 80 conducts a recording process with coating (S402), and the flow ends thereat. The recording process with coating will be described below.

If the ink cartridges 14 containing the black ink and the coating agent are not attached to the four cartridge attachable compartments 41 in the arrangement described above (S401: NO), the controller 80 determines whether the ink cartridges 14 all containing the black ink are attached to the four cartridge attachable compartments 41 (S403). If the ink cartridges 14 all containing the black ink are attached to the four cartridge attachable compartments 41 (S403: YES), the controller 80 conducts a recording process without coating (S404), and the flow ends thereat. The recording process without coating is substantially equal to the monochrome recording process (S104) in the embodiment described above.

If the ink cartridges 14 all containing the black ink are not attached to the four cartridge attachable compartments 41 (S403: NO), the controller 80 outputs an error signal that produces an error message, and the like, to the display 69 or the PC (not shown) connected to the printer 1 (S405), and the flow ends thereat.

The recording process with coating will be described herein. In the recording process with coating, similarly to the multicolor recording process in S102, the controller 80 may record an image on the recording sheet S by operating the printer 1 to repeat the set of the recording pass and the conveying action. Thereby, the black ink and the coating agent may be layered on the recording sheet S. Meanwhile, in the recording process with coating, in the recording pass, the black ink and the coating agent are discharged from the nozzles 10 in an arrangement such that the droplets of the coating agent may land on the black dots having landed on the recording sheet S earlier. Accordingly, the image formed of the black dots coated with the coating agent is recorded in the recording process with coating.

According to the eleventh modified example, the printer 1, in which the ink cartridges 14 containing the back ink are attached to the most leftward one and the second rightward one of the cartridge attachable compartments 41 in the scanning direction, and in which the coating-agent cartridges containing the coating agent are attached to the second leftward one and the most rightward one of the cartridge attachable compartments 41, may record a coated image by operating the inkjet head 4 to discharge the black ink and the coating agent from the nozzles 10 forming the four nozzle rows 9. On the other hand, when the four ink cartridges 14 all containing the back ink are attached to the four cartridge attachable compartments 41, the printer 1 may record an image without coating by operating the inkjet head 4 to discharge the black ink from the nozzles forming the four nozzle rows 9. In the case where the image without coating is recorded, the resolution of the image formed in each recording pass in the conveying direction may be higher than the resolution of the image with coating.

A twelfth modified example will be described with reference to FIG. 18A. The printer 1 according to the twelfth modified example is different from the printer 1 in the eleventh modified example in that preprocess-liquid cartridges containing preprocess liquid are attached to the second one of the cartridge attachable compartments 41 from the left and the most rightward one of the cartridge attachable compartments 41 in the scanning direction in place of the coating-agent cartridges.

In the twelfth modified example, the controller 80 may start a flow in a flowchart shown in FIG. 18A when the controller 80 receives a recording command. As shown in FIG. 18A, the controller 80 determines whether the ink cartridges 14 containing the black ink are attached to the most leftward one of the cartridge attachable compartments 41 and the second one of the cartridge attachable compartments 41 from the right in the scanning direction, and the preprocess-liquid cartridges containing the preprocess liquid are attached to the second one of the cartridge attachable compartments 41 from the left and the most rightward one of the cartridge attachable compartments 41 (S501).

If the ink cartridges 14 containing the black ink and the preprocess liquid are attached to the four cartridge attachable compartments 41 in the arrangement described above (S501: YES), the controller 80 conducts a recording process with preprocess (S502), and the flow ends thereat. The recording process with preprocess will be described below.

If the ink cartridges 14 and the preprocess-liquid cartridges containing the black ink and the preprocess liquid are not attached to the four cartridge attachable compartments 41 in the arrangement described above (S501: NO), the controller 80 determines whether the ink cartridges 14 all containing the black ink are attached to the four cartridge attachable compartments 41 (S503). If the ink cartridges 14 all containing the black ink are attached to the four cartridge attachable compartments 41 (S503: YES), the controller 80 conducts a recording process without preprocess (S504), and the flow ends thereat. The recording process without preprocess is substantially equal to the monochrome recording process (S104) in the embodiment described above.

If the ink cartridges 14 all containing the black ink are not attached to the four cartridge attachable compartments 41 (S503: NO), the controller 80 outputs an error signal that produces an error message, and the like, to the display 69 or the PC (not shown) connected to the printer 1 (S505), and the flow ends thereat.

The recording process with preprocess will be described herein. In the recording process with preprocess, similarly to the multicolor recording process in S102, the controller 80 may record an image on the recording sheet S by operating the printer 1 to repeat the set of the recording pass and the conveying action. Thereby, the black ink and the preprocess liquid may be layered on the recording sheet S. Meanwhile, in the recording process with preprocess, in the recording pass, the black ink and the preprocess liquid are discharged from the nozzles 10 in an arrangement such that the droplets of the black ink may land on the preprocess liquid having landed on the recording sheet S precedingly. Accordingly, the image formed of the black dots over a surface of the recording sheet S processed by the preprocess liquid is recorded in the recording process with preprocess. The preprocess may be, for example, a treatment to restrain the recording sheet S from swelling with the ink.

According to the twelfth modified example, the printer 1, in which the ink cartridges 14 containing the back ink are attached to the most leftward one and the second rightward one of the cartridge attachable compartments 41 in the scanning direction, and in which the preprocess-liquid cartridges containing the preprocess liquid are attached to the second leftward one and the most rightward one of the cartridge attachable compartments 41, may record an image with preprocess by operating the inkjet head 4 to discharge the black ink and the preprocess liquid from the nozzles 10 forming the four nozzle rows 9. On the other hand, when the four ink cartridges 14 all containing the back ink are attached to the four cartridge attachable compartments 41, the printer 1 may record an image without preprocess by operating the inkjet head 4 to discharge the black ink from the nozzles 10 forming the four nozzle rows 9. In the case where the image recording without preprocess is conducted, the resolution of the image formed in each recording pass in the conveying direction may be higher than the resolution of the image with preprocess.

A thirteenth modified example will be described with reference to FIG. 18B. The printer 1 according to the thirteenth modified example is different from the printer 1 in the eleventh modified example in that postprocess-liquid cartridges containing postprocess liquid are attached to the second one of the cartridge attachable compartments 41 from the left and the most rightward one of the cartridge attachable compartments 41 in the scanning direction in place of the coating-agent cartridges.

In the thirteenth modified example, the controller 80 may start a flow in a flowchart shown in FIG. 18B when the controller 80 receives a recording command. As shown in FIG. 18B, the controller 80 determines whether the ink cartridges 14 containing the black ink are attached to the most leftward one of the cartridge attachable compartments 41 and the second one of the cartridge attachable compartments 41 from the right in the scanning direction, and the postprocess-liquid cartridges containing the postprocess liquid are attached to the second one of the cartridge attachable compartments 41 from the left and the most rightward one of the cartridge attachable compartments 41 (S601).

If the ink cartridges 14 and the postprocess liquid cartridges containing the black ink and the postprocess liquid are attached to the four cartridge attachable compartments 41 in the arrangement described above (S601: YES), the controller 80 conducts a recording process with postprocess (S602), and the flow ends thereat. The recording process with postprocess will be described below.

If the ink cartridges 14 and the postprocess-liquid cartridges containing the black ink and the postprocess liquid are not attached to the four cartridge attachable compartments 41 in the arrangement described above (S601: NO), the controller 80 determines whether the ink cartridges 14 all containing the black ink are attached to the four cartridge attachable compartments 41 (S603). If the ink cartridges 14 all containing the black ink are attached to the four cartridge attachable compartments 41 (S603: YES), the controller 80 conducts a recording process without postprocess (S604), and the flow ends thereat. The recording process without postprocess is substantially equal to the monochrome recording process (S104) in the embodiment described above.

If the ink cartridges 14 all containing the black ink are not attached to the four cartridge attachable compartments 41 (S603: NO), the controller 80 outputs an error signal that produces an error message, and the like, to the display 69 or the PC (not shown) connected to the printer 1 (S605), and the flow ends thereat.

The recording process with postprocess will be described herein. In the recording process with postprocess, similarly to the multicolor recording process in S102, the controller 80 may record an image on the recording sheet S by operating the printer 1 to repeat the set of the recording pass and the conveying action. Thereby, the black ink and the postprocess liquid may be layered on the recording sheet S. Meanwhile, in the recording process with postprocessing, in the recording pass, the black ink and the postprocess liquid are discharged from the nozzles 10 in an arrangement such that the postprocess liquid may land on the dots of black ink having landed on the recording sheet S precedingly. Accordingly, the image formed of the black dots processed by the postprocess liquid is recorded in the recording process with postprocess. The postprocess may be, for example, a treatment to cure the ink on the recording sheet S.

According to the thirteenth modified example, the printer 1, in which the ink cartridges 14 containing the back ink are attached to the most leftward one and the second rightward one of the cartridge attachable compartments 41 in the scanning direction, and in which the postprocess-liquid cartridges containing the postprocess liquid are attached to the second leftward one and the most rightward one of the cartridge attachable compartments 41, may record an image with postprocess by operating the inkjet head 4 to discharge the black ink and the postprocess liquid from the nozzles 10 forming the four nozzle rows 9. On the other hand, when the four ink cartridges 14 all containing the back ink are attached to the four cartridge attachable compartments 41, the printer 1 may record an image without postprocess by operating the inkjet head 4 to discharge the black ink from the nozzles 10 forming the four nozzle rows 9. In the case where the image recording without postprocess is conducted, the resolution of the image formed in each recording pass in the conveying direction may be higher than the resolution of the image with postprocess.

In the eleventh through thirteenth modified examples, optionally, the coating-agent cartridges containing the coating agent, the preprocess-liquid cartridges containing the preprocess liquid, and the postprocess-liquid cartridges containing the postprocess liquid may be attached to the most leftward one of the cartridge attachable compartments 41 and the second one of the cartridge attachable compartments 41 from the right in the scanning direction, and the ink cartridges 14 containing the black ink may be attached to the second one of the cartridge attachable compartments 41 from the left in the scanning direction and the most rightward one of the cartridge attachable compartments 41.

In the embodiment and the modified examples described above, the nozzle surface 4b is parallel to the scanning direction and the conveying direction. In other words, a scan-projection direction, in which the scanning direction is projected on the nozzle surface 4b, is the same direction as the scanning direction. Moreover, a relative-movement projection direction, in which the conveying direction is projected on the nozzle surface 4b, is the same direction as the conveying direction. However, arrangement of the nozzle surface 4b with respect to the scanning direction and/or the conveying direction may not necessarily be limited to those described above.

For example, the nozzle surface 4b may incline to some extent with respect to the plane parallel to the scanning direction and the conveying direction. In a case where the nozzle surface 4b inclines in the scanning direction with respect to the plane parallel to the scanning direction and the conveying direction, the scan-projection direction, in which the scanning direction is projected on the nozzle surface 4b, may incline to some extent with respect the scanning direction. On the other hand, in a case where the nozzle surface 4b inclines in the conveying direction with respect to the plane parallel to the scanning direction and the conveying direction, the relative-movement projection direction, in which the conveying direction is projected on the nozzle surface 4b, may incline to some extent with respect to the conveying direction. Furthermore, in the latter case, a direction intersecting orthogonally with the scan-projection direction and the relative-movement projection direction inclines to some extent with respect to the vertical direction.

In the embodiment and the modified examples described above, the relative movement between the inkjet head 4 and the recording sheet S may be caused by conveying the recording sheet S in the conveying direction. However, the relative movement between the inkjet head 4 and the recording sheet S may not necessarily be caused by conveyance of the recording sheet S. For example, the ends of the guide rails 11, 12 in the scanning direction may be supported by a frame (not shown), which is movable in the conveying direction, and the frame may be moved in the conveying direction to move the inkjet head 4 in the conveying direction so that the inkjet head 4 and the recording sheet S may move relatively to each other in the conveying direction. In this arrangement, the frame is an example of the relative-movement device.

For another example, the present disclosure may not necessarily be applied to the printer that may record an image on the recording sheet S by discharging the ink(s) from the nozzles, but may be applied to a recording apparatus that may record an image on a recordable medium other than the recording sheet, such as T-shirt, sheet for outdoor advertisement, case for mobile terminal such as smartphone, cardboard, resin piece, etc.

What is claimed is:

1. A recording apparatus, comprising:
a head including a nozzle surface having a plurality of nozzles, the head being configured to discharge liquid from the plurality of nozzles;
a carriage on which the head is mounted, the carriage being movable in a scanning direction;
a relative-movement device configured to move the head and a recording medium relatively to each other in a relative-movement direction, the relative-movement direction intersecting with the scanning direction;
a first reservoir and a second reservoir configured to contain the liquid; and
a controller,
wherein the plurality of nozzles form:
a first nozzle row including a plurality of first nozzles connected to the first reservoir, the plurality of first nozzles being aligned along an aligning direction, the aligning direction intersecting with a scan-projection direction, the scan-projection direction being a direction in which the scanning direction is projected on the nozzle surface; and
a second nozzle row including a plurality of second nozzles connected to the second reservoir, the plurality of second nozzles being aligned along the aligning direction,
wherein the first nozzle row and the second nozzle row are located apart from each other in the scan-projection direction,
wherein, in a relative-movement projection direction in which the relative-movement direction is projected on the nozzle surface, each of the plurality of second nozzles except one of the plurality of second nozzles located on an end of the second nozzle row on one side in the aligning direction is located between two of the plurality of first nozzles adjoining in the aligning direction, and each of the plurality of first nozzles except one of the plurality of first nozzles located on an end of the first nozzle row on the other side in the aligning direction is located between two of the plurality of second nozzles adjoining in the aligning direction, and
wherein the controller is configured to repeat one of,
under a condition where the first reservoir and the second reservoir contain liquids in different types, a set of a multiple-liquids recording pass, in which the controller controls the carriage to move in the scanning direction and the head to discharge the liquids in the different types from the plurality of first nozzles and the plurality of second nozzles, and a first relative-movement action, in which the controller controls the relative-movement device to move the head and the recording medium relatively in the relative-movement direction, and
under a condition where the first reservoir and the second reservoir contain a liquid in a same type, a set of a single-liquid recording pass, in which the controller controls the carriage to move in the scanning direction and the head to discharge the liquid in the same type from the plurality of first nozzles and the plurality of second nozzles, a resolution of an image in the relative-movement direction recorded in the single-liquid recording pass being higher than a resolution of an image in the relative-movement direction recorded in the multiple-liquids recording pass, and a second relative-movement action, in which the controller controls the relative-movement device to move the head and the recording medium relatively in the relative-movement direction.

2. The recording apparatus according to claim 1, wherein
the plurality of first nozzles and the plurality of second nozzles are located at same positions in the aligning directions, and
the aligning direction is a direction intersecting with both the scan-projection direction and the relative-movement projection direction on the nozzle surface.

3. The recording apparatus according to claim 2, wherein an exterior shape of the head is a rectangle having a pair of opposing sides extending in parallel to the aligning direction in a view along a direction intersecting orthogonally with both the scan-projection direction and the relative-movement projection direction.

4. The recording apparatus according to claim 1, wherein the controller is configured to control the head to discharge the liquids in the different types in the multiple-liquids recording pass and to discharge the liquid in the same type in the single-liquid recording pass from the plurality of first nozzles and the plurality of second nozzles in an arrangement such that a size of each dot formed on the recording medium in the multiple-liquids recording pass is greater than or equal to a size of each dot formed on the recording medium in the single-liquid recording pass.

5. The recording apparatus according to claim 1, wherein the controller is configured to control the head to discharge the liquids in the different types in the multiple-liquids recording pass and to discharge the liquid in the same type in the single-liquid recording pass from the plurality of first nozzles and the plurality of second nozzles in an arrangement such that an amount of the liquid discharged from each of the plurality of first nozzles and the plurality of second nozzles in the multiple-liquids recording pass is greater than or equal to an amount of the liquid discharged from each of the plurality of first nozzles and the plurality of second nozzles in the single-liquid recording pass.

6. The recording apparatus according to claim 1, wherein
the controller is configured to repeat the set of the multiple-liquids recording pass and the first relative-movement action in an arrangement such that the liquids in the different types discharged from one of the plurality of first nozzles and one of the plurality of second nozzles are aimed at a spot to overlap one another to form a pixel on the recording medium, and
the controller is configured to repeat the set of the single-liquid recording pass and the second relative-movement action in an arrangement such that the liquid in the same type discharged from the plurality of first nozzles and the plurality of second nozzles are aimed at different spots to form different pixels on the recording medium.

7. The recording apparatus according to claim 1, wherein the first reservoir and the second reservoir are liquid cartridges detachably attached to the recording apparatus.

8. The recording apparatus according to claim 1, wherein
the first reservoir and the second reservoir each have an IC chip storing information concerning a type of the liquid contained a respective one of the first reservoir and the second reservoir,
the recording apparatus has information readers, each of which is configured to read the information concerning the type of the liquid contained in the respective one of the first reservoir and the second reservoir, and
the controller is configured to
under a condition where the information read from the information readers indicates that the first reservoir and the second reservoir contain the liquids in the different types, repeat the set of the multiple-liquids recording pass and the first relative-movement action, and
under a condition where the information read from the information readers indicates that the first reservoir and the second reservoir contain the liquid in the same type, repeat the set of the single-liquid recording pass and the second relative-movement action.

9. The recording apparatus according to claim 1, wherein the first reservoir and the second reservoir are liquid tanks, each having a refilling port for refilling a respective one of the first reservoir and the second reservoir with one of the liquids in the different types and the same type.

10. The recording apparatus according to claim 1, further comprising a selection-signal receiver configured to receive a selection signal from a user, the selection signal indicating a selection from the set of the multiple-liquids recording pass and the first relative-movement action and the set of the single-liquid recording pass and the second relative-movement action,
wherein the controller is configured to repeat one of the set of the multiple-liquids recording pass and the first relative-movement action and the set of the single-liquid recording pass and the second relative-movement action indicated in the selection signal received by the selection-signal receiver.

11. The recording apparatus according to claim 1, wherein the controller is configured to,
under a condition where the first reservoir and the second reservoir contain inks in different colors, repeat the set of the multiple-liquids recording pass and the first relative-movement action, and
under a condition where the first reservoir and the second reservoir contain ink in a same color, repeat the set of the single-liquid recording pass and the second relative-movement action.

12. The recording apparatus according to claim 1, wherein the controller is configured to,
under a condition where one of the first reservoir and the second reservoir contains pigment ink and the other of the first reservoir and the second reservoir contains dye ink, repeat the set of the multiple-liquids recording pass and the first relative-movement action, and
under one of conditions where the first reservoir and the second reservoir both contain pigment ink in a same color and where the first reservoir and the second reservoir both contain dye ink in a same color, repeat the set of the single-liquid recording pass and the second relative-movement action.

13. The recording apparatus according to claim 1, wherein the controller is configured to,
under a condition where one of the first reservoir and the second reservoir contains ink and the other of the first reservoir and the second reservoir contains a coating agent, repeat the set of the multiple-liquids recording pass and the first relative-movement action, and
under a condition where the first reservoir and the second reservoir contain ink in a same color, repeat the set of the single-liquid recording pass and the second relative-movement action.

14. The recording apparatus according to claim 1, wherein the controller is configured to,
under a condition where one of the first reservoir and the second reservoir contains ink and the other of the first reservoir and the second reservoir contains a processing liquid, repeat the set of the multiple-liquids recording pass and the first relative-movement action, and
under a condition where the first reservoir and the second reservoir contain ink in a same color, repeat the set of the single-liquid recording pass and the second relative-movement action.

15. A recording apparatus, comprising:
a head including a nozzle surface having a plurality of nozzles;
a carriage on which the head is mounted, the carriage being movable in a scanning direction;
a relative-movement device configured to move the head and a recording medium relatively to each other in a relative-movement direction, the relative-movement direction intersecting with the scanning direction;
a first reservoir and a second reservoir configured to contain liquid; and
a controller,
wherein the plurality of nozzles form:
a first nozzle row including a plurality of first nozzles connected to the first reservoir, the plurality of first nozzles being aligned in an aligning direction, the aligning direction intersecting with a scan-projection direction, the scan-projection direction being a direction in which the scanning direction is projected on the nozzle surface; and
a second nozzle row including a plurality of second nozzles connected to the second reservoir, the plurality of second nozzles being aligned in the aligning direction,
wherein the first nozzle row and the second nozzle row are located apart from each other in the scan-projection direction,
wherein, in a relative-movement projection direction in which the relative-movement direction is projected on the nozzle surface, each of the plurality of second nozzles except one of the plurality of second nozzles located on an end of the second nozzle row on one side in the aligning direction is located between two of the plurality of first nozzles adjoining in the aligning direction, and each of the plurality of first nozzles except one of the plurality of first nozzles located on an end of the first nozzle row on the other side in the aligning direction is located between two of the plurality of second nozzles adjoining in the aligning direction, and
wherein the controller is configured to repeat one of,
under a condition where the first reservoir and the second reservoir contain liquids in different types, a set of a multiple-liquids recording pass, in which the controller controls the carriage to move in the scanning direction and the head to discharge the liquids in the different types from the plurality of first nozzles and the plurality of second nozzles, and a first relative-movement action, in which the controller controls the relative-movement device to move the head and the recording medium relatively in the relative-movement direction, the liquids in the different types discharged from one of the plurality of first nozzles and one of the plurality of second nozzles being aimed at a spot to overlap one another to form a pixel on the recording medium, and
under a condition where the first reservoir and the second reservoir contain a liquid in a same type, a set of a single-liquid recording pass, in which the controller controls the carriage to move in the scanning direction and the head to discharge the liquid in the same type from the plurality of first nozzles and the plurality of second nozzles, and a second relative-movement action, in which the controller controls the relative-movement device to move the head and the recording medium relatively in the relative-movement direction, the liquid in the same type discharged from the plurality of first nozzles and the plurality of second nozzles being aimed at different spots to form different pixels on the recording medium.

16. A recording apparatus, comprising:
a head including a nozzle surface having a plurality of nozzles;
a carriage on which the head is mounted, the carriage being movable in a scanning direction;
a relative-movement device configured to move the head and a recording medium relatively to each other in a relative-movement direction, the relative-movement direction intersecting with the scanning direction;
a first reservoir and a second reservoir configured to contain liquid; and
a controller,
wherein the plurality of nozzles form:
a first nozzle row including a plurality of first nozzles connected to the first reservoir, the plurality of first nozzles being aligned in an aligning direction, the aligning direction intersecting with a scan-projection direction, the scan-projection direction being a direction in which the scanning direction is projected on the nozzle surface; and
a second nozzle row including a plurality of second nozzles connected to the second reservoir, the plurality of second nozzles being aligned in the aligning direction,
wherein the first nozzle row and the second nozzle row are located apart from each other in the scan-projection direction,
wherein, in a relative-movement projection direction in which the relative-movement direction is projected on the nozzle surface, each of the plurality of second nozzles except one of the plurality of second nozzles located on an end of the second nozzle row on one side in the aligning direction is located between two of the plurality of first nozzles adjoining in the aligning direction, and each of the plurality of first nozzles except one of the plurality of first nozzles located on an end of the first nozzle row on the other side in the aligning direction is located between two of the plurality of second nozzles adjoining in the aligning direction, and
wherein the controller is configured to repeat one of:
under a condition where the first reservoir and the second reservoir contain liquids in different types, a set of a first single-liquid recording pass, in which the controller controls the carriage to move in the scanning direction and the head not to discharge any of the liquids in the different types from the plurality of second nozzles but to discharge one of the liquids in the different types from the plurality of first nozzles, and a first relative-movement action, in which the controller controls the relative-movement device to move the head and the recording medium relatively in the relative-movement direction, and
under a condition where the first reservoir and the second reservoir contain a liquid in a same type, a set of a second single-liquid recording pass, in which the controller controls the carriage to move in the scanning direction and the head to discharge the liquid in the same type from the plurality of first nozzles and the plurality of second nozzles, a resolution of an image in the relative-movement direction recorded in the second single-liquid recording pass being higher than a resolution of an image in the relative-movement direction recorded in the first single-liquid recording pass, and a second relative-movement action, in which the controller controls the relative-movement device to move the head and the recording medium relatively in the relative-movement direction.

17. A recording apparatus, comprising:
a head including a nozzle surface having a plurality of nozzles;
a carriage on which the head is mounted, the carriage being movable in a scanning direction;
a relative-movement device configured to move the head and a recording medium relatively to each other in a relative-movement direction, the relative-movement direction intersecting with the scanning direction;
a first reservoir and a second reservoir configured to contain liquid; and
a controller,
wherein the plurality of nozzles form:
a first nozzle row including a plurality of first nozzles connected to the first reservoir, the plurality of first nozzles being aligned in an aligning direction, the aligning direction intersecting with a scan-projection direction, the scan-projection direction being a direction in which the scanning direction is projected on the nozzle surface; and
a second nozzle row including a plurality of second nozzles connected to the second reservoir, the plurality of second nozzles being aligned in the aligning direction,
wherein the first nozzle row and the second nozzle row are located apart from each other in the scan-projection direction,
wherein, in a relative-movement projection direction in which the relative-movement direction is projected on the nozzle surface, each of the plurality of second nozzles except one of the plurality of second nozzles located on an end of the second nozzle row on one side in the aligning direction is located between two of the plurality of first nozzles adjoining in the aligning direction, and each of the plurality of first nozzles except one of the plurality of first nozzles located on an end of the first nozzle row on the other side in the aligning direction is located between two of the plurality of second nozzles adjoining in the aligning direction, and
wherein the controller is configured to repeat one of:
under a condition where the first reservoir and the second reservoir contain liquids in different types, a set of a multiple-liquids recording pass, in which the controller controls the carriage to move in the scanning direction and the head to discharge the liquids in the different types from the plurality of first nozzles and the plurality of second nozzles, and a first relative-movement action, in which the controller controls the relative-movement device to move the head and the recording medium relatively in the relative-movement direction, to record an image on the recording medium, the image recorded in the set of multiple-liquids recording pass and the first relative-movement action including a pixel formed of one of the liquids in the different types discharged from one of the plurality of first nozzles and another of the liquids in the different types discharged from one of the plurality of second nozzles located at a different position from the one of the plurality of first nozzles in the relative-movement direction, and
under a condition where the first reservoir and the second reservoir contain a liquid in a same type, a set of a single-liquid recording pass, in which the controller controls the carriage to move in the scanning direction and the head to discharge the liquid in the same type from the plurality of first nozzles and the plurality of second nozzles, and a second relative-movement action, in which the controller controls the relative-movement device to move the head and the recording medium relatively in the relative-movement direction, to record an image on the recording medium, the image recorded in the set of the single-liquid recording pass and the second relative-movement action including a pixel formed of the liquid in the same type discharged from one of the plurality of first nozzles and a different pixel formed of the liquid in the same type discharged from one of the plurality of second nozzles located at a different position from the one of the plurality of first nozzles in the relative-movement direction.

18. A recording apparatus, comprising:
a head including a nozzle surface having a plurality of nozzles, the head being configured to discharge liquid from the plurality of nozzles;
a carriage on which the head is mounted, the carriage being movable in a scanning direction;
a relative-movement device configured to move the head and a recording medium relatively to each other in a relative-movement direction, the relative-movement direction intersecting with the scanning direction;
a first reservoir and a second reservoir configured to contain the liquid; and
a controller,
wherein the plurality of nozzles form:
a first nozzle row including a plurality of first nozzles connected to the first reservoir, the plurality of first nozzles being aligned along an aligning direction, the aligning direction intersecting with a scan-projection direction, the scan-projection direction being a direction in which the scanning direction is projected on the nozzle surface; and
a second nozzle row including a plurality of second nozzles connected to the second reservoir, the plurality of second nozzles being aligned along the aligning direction,
wherein the first nozzle row and the second nozzle row are located apart from each other in the scan-projection direction,
wherein, in a relative-movement projection direction in which the relative-movement direction is projected on the nozzle surface, each of the plurality of second nozzles except one of the plurality of second nozzles located on an end of the second nozzle row on one side in the aligning direction is located between two of the plurality of first nozzles adjoining in the aligning direction, and each of the plurality of first nozzles except one of the plurality of first nozzles located on an end of the first nozzle row on the other side in the aligning direction is located between two of the plurality of second nozzles adjoining in the aligning direction, and
wherein, under a condition where the first reservoir and the second reservoir contain liquids in different types, the controller is configured to repeat a set of:
a multiple-liquids recording pass, in which the controller controls the carriage to move in the scanning direction and the head to discharge the liquids in the different types from the plurality of first nozzles and the plurality of second nozzles, the liquids discharged from one of the plurality of first nozzles and from one of the plurality of second nozzles being aimed at a spot to overlap one another to form a pixel on the recording medium; and
a first relative-movement action, in which the controller controls the relative-movement device to move the head and the recording medium relatively in the relative-movement direction.
